(19) United States
(12) Patent Application Publication
(10) Pub. No.: US 2015/0118031 A1
(43) Pub. Date: Apr. 30, 2015

(54) SYSTEM AND A METHOD OF INSTALLING A TIP SHROUD RING IN TURBINE DISKS

(71) Applicant: KRISHNA KUMAR BINDINGNAVALE RANGA, Bangalore (IN)

(72) Inventor: KRISHNA KUMAR BINDINGNAVALE RANGA, BANGALORE (IN)

(21) Appl. No.: 14/513,490

(22) Filed: Oct. 14, 2014

(30) Foreign Application Priority Data
Oct. 25, 2013 (IN) 1809/CHE/2013

(51) Int. Cl. F01D 11/12; B23P 15/00; F01D 5/22

(52) U.S. Cl. CPC F01D 11/122; F01D 5/225; B23P 15/006; F05D 2230/60; F05D 2220/31
USPC 415/173.4; 415/173.1; 29/889.21

(57) ABSTRACT

The various embodiments of the present invention provide a method for installing a tip shroud on a turbine disk in a steam turbine. A tip shroud in the form of a ring is installed on the outer periphery of the turbine disk to prevent a leakage of the driving fluid. The method comprises the steps of mounting turbine disk on to a rotor shaft, tapering the outer diameter of the turbine disk and the inner diameter of the tip shroud, aligning and mounting the tapered surface of the turbine disk with the tapered surface of the tip shroud and fastening the tip shroud on the turbine disk with the help of fasteners. The bolted tip shroud is finally machined to reduce the outer peripheral diameter to appropriate dimensions.

### CROSS REFERENCE TO RELATED APPLICATIONS

This patent application claims the priority of the Indian Provisional Patent Application No. 1809/CHE/2013 filed on Apr. 25, 2013, and postdated to Oct. 25, 2013 with the title “A Method of Installing a Tip Shroud Ring in Turbine Disks”, and the content of which is incorporated in entirety by reference herein.

### BACKGROUND

1. Technical Field

The embodiments herein generally relate to the turbine and particularly related to an arrangement of a tip shroud on a turbine rotor disk in a turbine. The embodiments herein are more particularly related to a method of installing a ring type tip shroud in the turbine disks for offsetting the performance losses.

2. Description of the Related Art

The turbine is a machine which converts the energy stored in a fluid to useful work. Generally, a turbine comprises of a shaft and a circular disk or a ring. The circular disk comprises a series of blades or multiplicity of blades attached to its outer periphery. The series of blades are aligned based on a specific speed and an application of the turbines. There are numerous types of turbines depending on the type of inputs, such as steam, water, wind, gas, etc.

The blades of the turbine enable a transfer of momentum from the fluid to the disk, which in turn spins/rotates a shaft. The design of these blades is critical to the performance of the turbine and the blades employ a feature called a ‘Tip shroud’ on their outer periphery to prevent the driving fluid from escaping through a gap between the blades and the end wall of an enclosing manifold. In most of the existing turbines, the rotor blades are inserted individually to the slots present on the periphery of the turbine disk. So the tip shroud is manufactured integrally with the blade for preventing the driving fluid from escaping from the drive path. Hence an independent tip shroud is present for each blade of the turbine disk. Although this type of construction minimizes a leakage of the driving fluid, it is not as mechanically sound when compared to a turbine disk with integrally machined blades. This type of construction is called a bladed disk or ‘Blisk’ and an existing method for installing a tip shroud individually on each blade for such disks is neither feasible nor reliable.

Hence, there is a need for a simple and improved method for installing a tip shroud over the outer periphery of the turbine disk, more specifically a bladed disk, thereby preventing the escape of the driving fluid and increasing efficiency of the steam turbine.

### OBJECTIVES OF THE EMBODIMENTS

The primary object of the embodiments herein is to provide a method and system for blocking the leakage of driving fluid through a gap between the rotor blades and end wall of the enclosing manifold.

Another object of the embodiments herein is to provide a ring type tip shroud structure to block the leakage of the driving fluid.

Yet another object of the embodiments herein is to provide a method for assembling a ring type tip shroud over the rotor disk of a turbine.

Yet another object of the embodiments herein is to provide a method for assembling the tip shroud ring over bladed turbine disks or Blisks.

These and other objects and advantages of the embodiments herein will become readily apparent from the following detailed description taken in conjunction with the accompanying drawings.

### SUMMARY

The various embodiments herein provide a turbine with an improved tip shroud ring. The tip shroud ring is configured to contain the leakage of a driving fluid. The turbine comprises a turbine disk mounted on to an end of the rotor shaft. The turbine disk comprises a plurality of rotor blades configured to rotate the turbine disk with the influence of pressure from the driving fluid. The turbine further comprises a nozzle fixed directly behind the rotor blades of the turbine disk. The nozzle is configured to accelerate the flow of the driving fluid through the rotor blades. An inlet manifold enclosing a plurality of internal components of the turbine is configured to transfer the driving fluid from a fluid inlet line to the nozzle. The inlet manifold is fixed to the outlet manifold. The outlet manifold is configured to exhaust the expanded driving fluid from the turbine.

According to one embodiment herein, the tip shroud ring is fastened to an inner periphery of the inlet manifold by a plurality of bolts. The tip shroud ring is mounted directly above a circular periphery of the turbine disk through a plurality of turbine bolts.

According to one embodiment herein, the plurality of bolts is fastened to each rotor blade to prevent axial movement of the tip shroud ring.

According to one embodiment herein, the inner periphery of the tip shroud ring is covered with a soft abradable coating. The coating on the shroud ring provides protection to a plurality of rotating components of the turbine from damage in case of contact with the shroud ring.

According to one embodiment herein, a gap is provided between the tip of the rotor blades and the inner surface of the shroud ring. The gap is configured to facilitate the free rotation of the turbine disk.

According to one embodiment herein, the tip shroud ring prevents the driving fluid from escaping through the gap between the tip of the rotor blades and the inner surface of the shroud ring.

According to one embodiment herein, the rotor shaft of the steam turbine is provided with a plurality of labyrinth seal knives. The seal knives are configured to prevent the leakage of the driving fluid.

The various embodiments of the herein provide an improved method for installing the tip shroud on the turbine disk in the turbine. The method comprises the steps of mounting the turbine disk on to the rotor shaft. The outer periphery of the turbine disk is machined to a predetermined taper angle. The ring tip shroud of a preferred dimension and material is chosen. The inner periphery of the ring shroud is affixed to the tapered surface on the turbine disk. The tapered surface of the tip shroud aligns with the tapered periphery of the turbine disk. The ring tip shroud is assembled onto the turbine disk, where the tip shroud is drilled and fastened to the plurality of rotor blades by a plurality of fasteners. The outer periphery of the tip shroud is adjusted to a predetermined standard dimension, after the installation of the tip shroud onto the turbine disk.

According to one embodiment herein, the tip shroud ring prevents a leakage of the driving fluid through the gap between a blade and an end wall of an inlet manifold, as the fluid flows through a drive path.

According to one embodiment herein, the tip shroud is firmly fastened to the rotor through the holes drilled and tapped with each blade.

According to one embodiment herein, the fitting of the tip shroud tightens when the driving fluid is passed through the drive passage. The tightening of the tip shroud reduces the chances of an axial play of the tip shroud.

The various embodiments herein provide an improved method for installing a tip shroud on a turbine disk in a steam turbine. The tip shroud is installed on the steam turbine which comprises a series of rotor blades at the outer periphery of the turbine disk. The rotor blades are machined integrally with the turbine disk to provide a better mechanical strength. The tip shroud is a ring with a tapered inner diameter which is fastened to the blades of the turbine disk of the turbine. The method of manufacturing and installing the tip shroud on the turbine disk comprises the following steps. The rotor is manufactured to the finished dimensions and is provided with a taper on the outer periphery. Then the tip shroud in a pre-machined condition is provided with a taper on its inner periphery. The tip shroud is then assembled onto the rotor by drilling and tapping at one blade with the help of one fastener. The tip shroud assembly is then drilled, tapped and then fastened at each blade to provide a firm fit. Finally, the tip shroud is machined to final dimensions.

According to one embodiment herein, an improved tip shroud for the steam turbines is provided. The tip shroud is a ring of a predetermined material and thickness with a taper provided on the inner diameter. The tip shroud is mounted over the tapered turbine disk and held in place with the help of fasteners. The ring type tip shroud is stronger than conventional tip shroud designs due to a ring structure. The tip shroud prevents the leakage of the driving fluid by reducing the gaps between the rotor blades and the end wall of an enclosing manifold.

According to one embodiment herein, the mounting of the tip shroud is such that when the driving fluid is passed through the drive passage, the fitting of tip shroud only tightens thereby reducing chances of any axial play of the tip shroud.

According to one embodiment herein, the tip shroud ring is provided with labyrinth seal knives. The labyrinth seal knives help in preventing the leakage of the driving fluid.

According to one embodiment herein, the method of installing the tip shroud is applicable to all rotating machinery in various industries such as turbo machinery industry, power industry etc.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a cross sectional view of a steam turbine indicating an assembly of a tip shroud on a turbine disk, according to one embodiment herein.

FIG. 2 illustrates a magnified cross sectional view of a tip shroud assembly on a turbine disk, according to one embodiment herein.

FIG. 3 illustrates a flow chart explaining a method of installing a tip shroud ring on a turbine disk of a steam turbine, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a turbine with an improved tip shroud ring. The tip shroud ring is configured to contain the leakage of a driving fluid. The turbine comprises a turbine disk mounted on to an end of the rotor shaft. The turbine disk comprises a plurality of rotor blades configured to rotate the turbine disk with the influence of pressure from the driving fluid. The turbine further comprises a nozzle fixed directly behind the rotor blades of the turbine disk. The nozzle is configured to accelerate the flow of the driving fluid through the rotor blades. An inlet manifold enclosing a plurality of internal components of the turbine is configured to transfer the driving fluid from a fluid inlet line to the nozzle. The inlet manifold is fixed to an outlet manifold. The outlet manifold is configured to exhaust the expanded driving fluid from the turbine.

According to one embodiment herein, the tip shroud ring is fastened to an inner periphery of the inlet manifold by a plurality of bolts. The tip shroud ring is mounted directly above a circular periphery of the turbine disk through a plurality of turbine bolts.

According to one embodiment herein, the plurality of bolts is fastened to each rotor blade to prevent axial movement of the tip shroud ring.

According to one embodiment herein, the inner periphery of the tip shroud ring is covered with a soft abradable coating. The coating on the shroud ring provides protection to a plurality of rotating components of the turbine from damage in case of contact with the shroud ring.

According to one embodiment herein, a gap is provided between the tip of the rotor blades and the inner surface of the shroud ring. The gap is configured to facilitate the rotation of the turbine disk.

According to one embodiment herein, the tip shroud ring prevents the driving fluid from escaping through the gap between the tip of the rotor blades and the inner surface of the shroud ring.

According to one embodiment herein, the rotor shaft of the steam turbine is provided with a plurality of labyrinth seal knives. The seal knives are configured to prevent the leakage of the driving fluid.

The various embodiments herein provide an improved method for installing the tip shroud on the turbine disk in the turbine. The method comprises the steps of mounting the turbine disk on to the rotor shaft. The outer periphery of the turbine disk is machined to a predetermined taper angle. The ring tip shroud of a preferred dimension and material is chosen. The inner periphery of the ring shroud is affixed to the tapered surface on the turbine disk. The tapered surface of the tip shroud aligns with the tapered periphery of the turbine disk. The ring tip shroud is assembling onto the turbine disk, where the tip shroud is drilled and fastened to the plurality of rotor blades by a plurality of fastener. The outer periphery of the tip shroud is adjusted to a predetermined standard dimension, after the installation of the tip shroud onto the turbine disk.

According to one embodiment herein, the tip shroud ring prevents a leakage of the driving fluid through the gap between a blade and an end wall of an inlet manifold, as the fluid flows through a drive path.

According to one embodiment herein, the tip shroud is firmly fastened to the rotor through the holes drilled and tapped with each blade.

According to one embodiment herein, the fitting of the tip shroud tightens when the driving fluid is passed through the drive passage. The tightening of the tip shroud reduces the chances of an axial play of the tip shroud.

The various embodiments herein provide an improved method for installing a tip shroud on a turbine disk in a turbine. The tip shroud is installed on the rotor disk of a turbine which comprises of a series of rotor blades at the outer periphery. The rotor blades of the turbine disk are machined integrally with the turbine disk to provide a better mechanical strength. The tip shroud is a ring with a tapered inner diameter which is fastened to the turbine disk of the turbine. The method of manufacturing and installing the tip shroud on the turbine disk comprises the following steps; first the rotor is manufactured to finished dimensions and is provided with a taper on the outer periphery. Then the tip shroud in pre-machined condition is provided with a taper on its inner periphery. The tip shroud is then assembled onto the rotor by drilling and tapping at one blade with the help of one fastener. The tip shroud assembly is then drilled, tapped and then fastened at each blade. Finally, the tip shroud is machined to final dimensions.

According to one embodiment herein, an improved tip shroud for the steam turbines is provided. The tip shroud is a ring of a predetermined material and thickness with a taper provided on the inner diameter. The tip shroud is mounted over the tapered outer periphery of the turbine disk. The ring type tip shroud provides ease of assembly and is also stronger due to ring structure. The tip shroud prevents the leakage of the driving fluid by reducing the gaps between the rotor blades and the end wall of an enclosing manifold.

According to one embodiment herein, the mounting of the tip shroud is such that when the driving fluid is passed through the drive passage; the fitting of the tip shroud only tightens, thereby reducing chances of any axial play of the tip shroud.

According to one embodiment herein, the tip shroud is provided with labyrinth seal knives. The labyrinth seal knives help in preventing the leakage of the driving fluid.

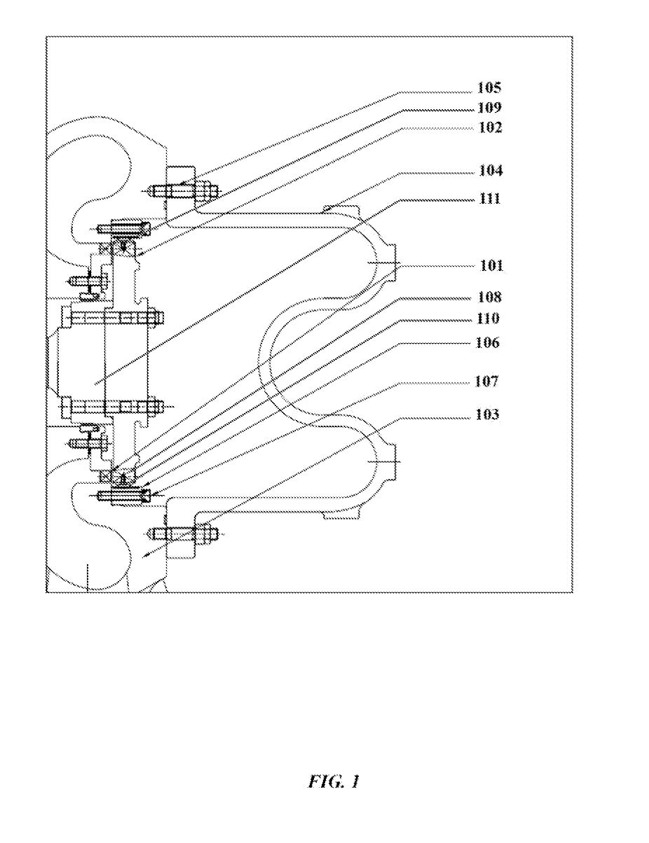

FIG. 1 illustrates a cross sectional view of a steam turbine indicating an assembly of a tip shroud on a turbine disk, according to one embodiment herein. The turbine disk 102 is mounted on to the one end of the rotor shaft 111. The turbine disk 102 is bolted to the rotor shaft 111 with the help of turbine bolts and providing interference fit as shown in FIG. 1. The turbine disk 102 has a plurality of rotor blades 108. A nozzle ring 101 is fixed directly behind the blades 108 of the turbine disk 102. The nozzle ring 101 is used to accelerate the flow of driving fluid through the rotor blades 108. When the driving fluid, such as steam, hits the turbine blades 108, the turbine disk 102 rotates and which in turn rotates a generator for generating the electric power. The turbine disk is enclosed within two casings namely the inlet manifold 103 and the outlet manifold 104. The inlet manifold 103 transfers the steam from the steam inlet line to the nozzle, and encloses the internal components of the turbine. The outlet manifold 104 is fixed to the inlet manifold 103 through the stud bolts 105 and is used to exhaust the expanded driving fluid. The inlet manifold 103 further comprises a shroud ring 106. The shroud ring 106 is mounted directly above the circular periphery of the turbine disk 102. The shroud ring 106 is applied with a soft abradable coating 109 on the inner periphery. The shroud ring 106 is fastened to the inner periphery 103 of the manifold by means of the bolts 107. The shroud ring 106 with the abradable coating 109 protects the rotating components from damage in case of contact with the shroud ring 106. There is a small gap/region between the tip of the rotor blades 108 and the inner surface of the shroud ring 106 to facilitate the rotation of the turbine disk. Normally, the driving fluid escapes through this gap (between the tip of the rotor blades 108 and the inner surface of the shroud ring 106). A tip shroud ring 110 is provided to contain the leakage of the driving fluid. The tip shroud ring 110 is a ring structure which is installed over turbine disk 102. The tip shroud ring reduces the leakage of the driving fluid and thus increases the efficiency of the steam turbine.

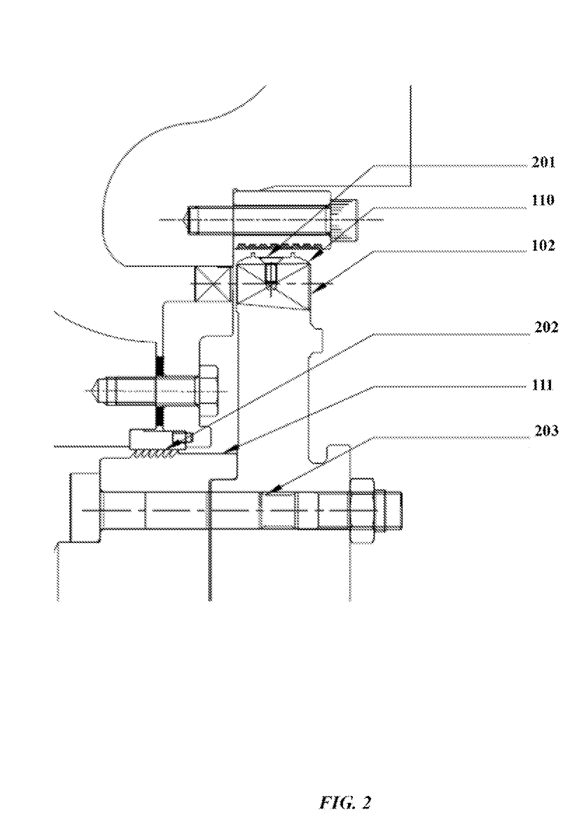

FIG. 2 illustrates a magnified cross sectional view of a steam turbine indicating an assembly of a tip shroud on a turbine disk, according to one embodiment herein. A turbine disk 102 is fixed to a rotor shaft 111. The rotor shaft of the steam turbine is provided with a plurality of labyrinth seal knives 202. The seal knives 202 help in preventing the leakage of the driving fluid. The outer periphery of turbine disk 102 is installed with a tip shroud ring 110. The tip shroud ring 110 is fixed to the turbine disk 102 through bolts 201. The bolts 201 are fastened to each rotor blade to prevent axial movement of the tip shroud ring 110. The turbine disk 203 is mounted on to the rotor shaft 111.

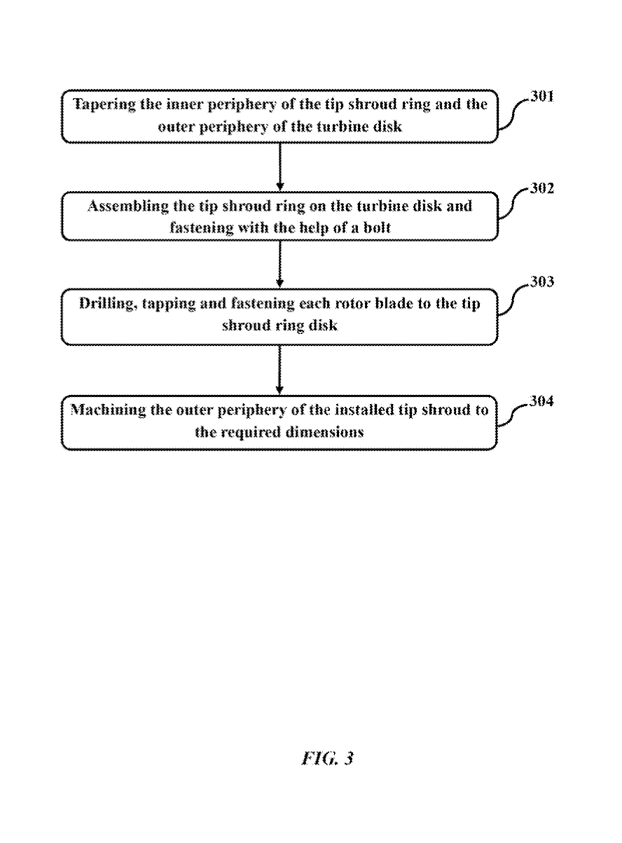

FIG. 3 illustrates a flow chart explaining a method of installing a tip shroud ring on a turbine disk of a steam turbine, according to one embodiment herein. The method of installing the tip shroud ring on the turbine disk of the steam turbine comprises the steps of machining an outer periphery of the turbine disk to a predetermined taper angle. Then a ring of preferred dimensions and material is chosen and the inner periphery of the ring is then machined to a tapered shape such that the tapered surface of the tip shroud aligns with the tapered periphery of the turbine disk (301). After the inner diameter tip shroud ring is machined to a required taper, the tip shroud ring is assembled over the turbine disk and drilled tapped and fastened to a single rotor blade by means of a fastener (302). Then the holes are drilled and tapped through each blade and the tip shroud firmly fastened to the rotor by means of fasteners (303). After the installation of the tip shroud, the outer periphery of the tip shroud is machined to a predetermined standard dimensions. When a driving fluid flows/passes through the drive path, the tip shroud ring prevents the leakage of fluid through the gap between the blade and the end wall of the inlet manifold and enhances performance (304).

The embodiments herein disclose a method of installing the tip shroud is applicable to all rotating machinery in various industries such as turbo machinery industry, power industry etc. The tip shroud blocks a leakage of the driving fluid through a gap between the rotor blades and an end wall of the enclosing manifold. The ring type structure of tip shroud provides an ease of assembly and the shroud is also stronger due to ring structure. The method also facilitates assembling of a ring type tip shroud over the bladed rotor disk of the turbine.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications.

Although the embodiments herein are described with various specific embodiments, it will be obvious for a person skilled in the art to practice the embodiments herein with modifications.

It is also to be understood that the following claims are intended to cover all of the generic and specific features of the embodiments described herein and all the statements of the scope of the embodiments which as a matter of language might be said to fall there between.

What is claimed is:

1. A method for installing a tip shroud ring on a turbine disk of a turbine, comprising steps of:
mounting a turbine disk on to a rotor shaft;
machining an outer periphery of the turbine disk to a predetermined taper angle;
choosing a ring tip shroud of a desired dimension and material;
affixing an inner periphery of the ring shroud to a tapered surface on the turbine disk, in such a manner that a tapered surface of the tip shroud aligns with the tapered periphery of the turbine disk;
assembling the ring tip shroud onto the turbine disk, and wherein the tip shroud is drilled and fastened to a plurality of rotor blades by a plurality of fasteners; and
adjusting the outer periphery of the tip shroud to a predetermined dimension, after an installation of the tip shroud onto the turbine disk.

2. The method according to claim 1, wherein the tip shroud ring is configured to prevent a leakage of a driving fluid through a gap between a blade and an end wall of an inlet manifold, as the fluid flows through a drive path.

3. The method according to claim 1, wherein the tip shroud is fastened to the rotor through the holes drilled and tapped with each blade.

4. The method according to claim 1, wherein a fitting of the tip shroud is tightened, when the driving fluid is passed through the drive passage, and wherein the tightening of the tip shroud reduces a chance of an axial play of the tip shroud.

5. A turbine with an improved tip shroud ring comprising:
a turbine disk mounted on to an end of the rotor shaft, and wherein the turbine disk comprises a plurality of rotor blades configured to rotate the turbine disk based on a pressure from a driving fluid;
a nozzle fixed directly behind the rotor blades of the turbine disk, and wherein the nozzle is configured to accelerate a flow of the driving fluid through the rotor blades;
an inlet manifold enclosing a plurality of internal components of the turbine, and wherein the inlet manifold is configured to transfer the driving fluid from a fluid inlet line to the nozzle; and
an outlet manifold configured to exhaust the expanded driving fluid from the turbine, and wherein the outlet manifold is fixed to the inlet manifold,
and wherein the tip shroud ring is configured to reduce the leakage of the driving fluid.

6. The system according to claim 5, wherein the shroud ring is fastened to an inner periphery of the inlet manifold by a plurality of bolts and wherein the tip shroud ring is mounted directly above a circular periphery of the turbine disk through a plurality of turbine bolts.

7. The system according to claim 5, wherein the plurality of bolts are fastened to each rotor blade to prevent an axial movement of the tip shroud ring.

8. The system according to claim 5, wherein the inner periphery of the tip shroud ring is covered with a soft abradable coating, and wherein the coating on the shroud ring provides protection to a plurality of rotating components of the turbine from damage in case of contact with the shroud ring.

9. The system according to claim 5, wherein a gap is provided between the tip of the rotor blades and the inner surface of the shroud ring, and wherein the gap is configured to facilitate a rotation of the turbine disk.

10. The system according to claim 5, wherein the tip shroud ring is configured to prevent the driving fluid from escaping through the gap between the tip of the rotor blades and the inner surface of the shroud ring.

11. The system according to claim 5, wherein the rotor shaft of the steam turbine is provided with a plurality of labyrinth seal knives, and wherein the seal knives are configured to prevent the leakage of the driving fluid.
